(19) United States
(12) Patent Application Publication
(10) Pub. No.: US 2005/0279559 A1
(43) Pub. Date: Dec. 22, 2005

(54) Airbag type safety device

(75) Inventor: Gerard Thevenot, Messigny-les-Vantoux (FR)

Correspondence Address: YOUNG & THOMPSON, 745 SOUTH 23RD STREET, 2ND FLOOR, ARLINGTON, VA, 22202, US

(73) Assignee: Helite (Sarl), Messigny-ET-Vantoux (FR)

(21) Appl. No.: 10/524,146

(22) PCT Filed: Aug. 14, 2003
(86) PCT No.: PCT/FR03/02537

§ 371 Date: Feb. 11, 2005

(30) Foreign Application Priority Data
Aug. 14, 2002 (FR) 02/10305

(51) Int. Cl. B60K 28/00; B60D 1/28

(52) U.S. Cl. 180/271

(57) ABSTRACT

A safety device associated with a transport, or with its pilot's body or the body of any other person practising a sport or a hazardous activity to protect the body, includes an inflatable airbag connected to inflating elements automatically or manually activated upon an impact. The airbag has a frame including at least one tubular element for forming a geometrical frame, when the tubular element is inflated, the latter being initially folded in a container integral, for instance, with the transport and/or the human body and connected to the inflating elements and an outer wall made of a flexible material integral with the frame so as to form a closed chamber filled with air at atmospheric pressure, the outer wall including at least one valve.

The invention relates to a safety device, disassociated or integral with a means of transport, with its pilot's body or with the body of any other person practising a hazardous sport or activity, of “airbag” type which is a registered trademark, comprising an airbag made in cloth or like connected to inflating means automatically or manually activated so as to inflate said airbag at the time of impact.

In the field of airbag type safety devices, we already know of devices comprising an airbag made in cloth or like connected to inflating means automatically or manually activated so as to inflate said airbag at the time of impact, said device being contained in a casing integral with the means of transport or in a backpack worn by the pilot of said means of transport. This is the case, for example, of the German utility model DE 2.971.7771 describing a protective device to protect the human body at the time of impact with an obstacle. The device comprises two airbags initially contained in a backpack for example and which is deployed in a semi-cylindrical manner at the time of impact with an obstacle so that said airbags surround the torso, that being the bust of the user. The airbags are inflated with a compressed air device triggered by a hand-operable rip cord constituted of a cable fitted with a ring at its loose end. According to an alternative means of operating the device, the airbags are constituted of inflatable longitudinal tubular elements which reunite after being inflated to form a frame of overall hemispheric shape surrounding the user of the device.

This type of airbag safety device has the inconvenience of needing, in order to be inflated, an especially long time and a large volumetric capacity of compressed air which are not compatible with the reaction time of about a millisecond, needed for the efficient use of these devices, nor with a necessarily limited encumbrance. Furthermore, the alternative means of operating consisting of the inflatable longitudinal tubular elements bearing the inconvenience of not protecting the user between two adjacent tubular elements.

One of the purposes of the invention is therefore to overcome all of these inconveniences by proposing a safety device comprising a simply designed and low cost airbag so as to efficiently protect the human body of the user.

For this reason and according to the invention, a safety device independent or integral with a means of transport or with its pilot's body is proposed to protect said body, comprising an airbag made in cloth or like connected to inflating means automatically or manually activated so as to inflate said airbag at the time of impact; said device is remarkable in that the airbag is constituted, on one hand, of a frame comprising at least a tubular element so as to form a cylindrical, spherical, parallelepiped or like frame, when said tubular element is inflated, said tubular element being initially folded in a container integral, for instance, with the means of transport and/or a human body and connected to the inflating means and, on the other hand, of an outer wall made of a flexible material integral with the frame so as to form a closed chamber filled with air at atmospheric pressure, said outer wall comprising at least one valve which opens when the frame is being inflated and which closes at the time of impact.

We fully understand that, contrary to the devices of the prior art, the air contained in the airbag is at atmospheric pressure after the tubular elements have been inflated with compressed air or by pyrotechnic means, said tubular elements forming a frame which then allows to deploy, by means of a bottle of compressed gas of little continence, that meaning of little encumbrance, one or several airbags capable of absorbing the impact by providing an especially vast volume of air. Thus, according to the device of the invention, the entire human body can be protected in an especially short reaction time.

Other advantages and features will become clearer from the descriptions of alternative means of operating that follow, given by way of example and non restrictive, of the safety device according to the invention and in reference to the annexed drawings in which:

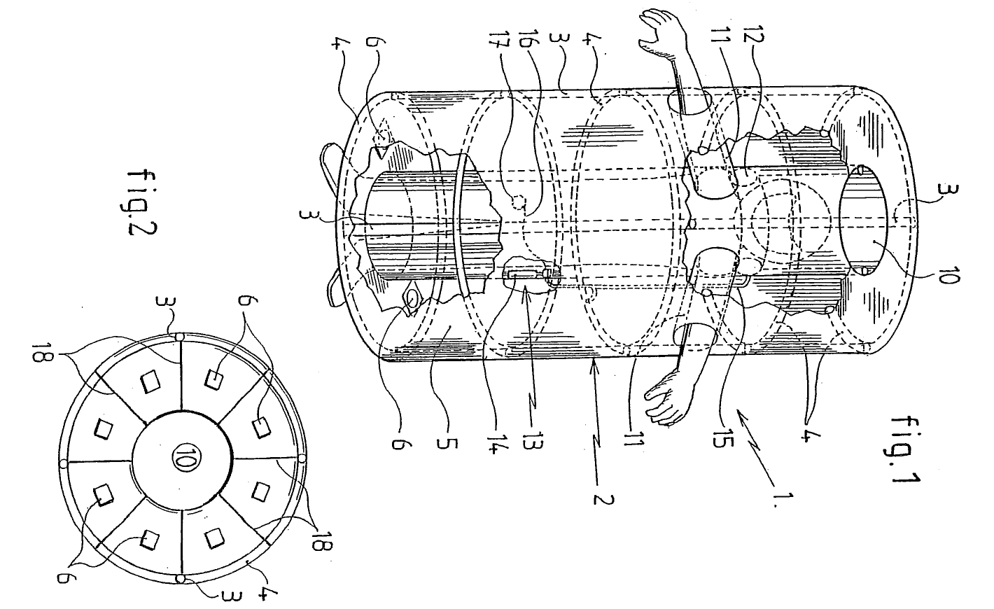

FIG. 1 is a perspective view of a first embodiment of the safety device according to the invention in the inflated state;

FIG. 2 is a cross section view of an embodiment of the safety device according to the invention represented in FIG. 1;

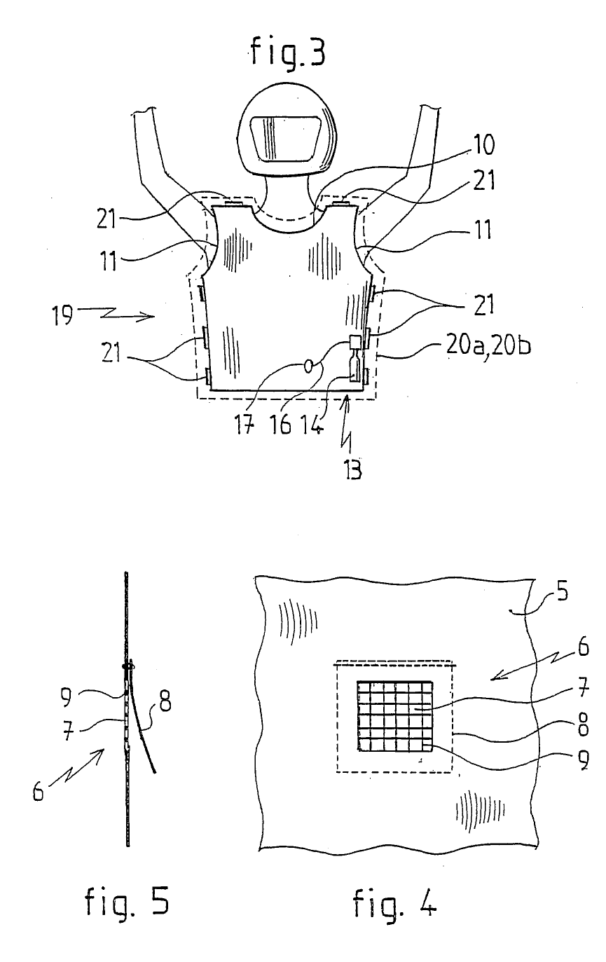

FIG. 3 is a front view diagram of the safety device according to the invention worn by a motorcyclist;

FIG. 4 is a front view of a valve of the safety device according to the invention;

FIG. 5 is a top view of a valve of the safety device according to the invention;

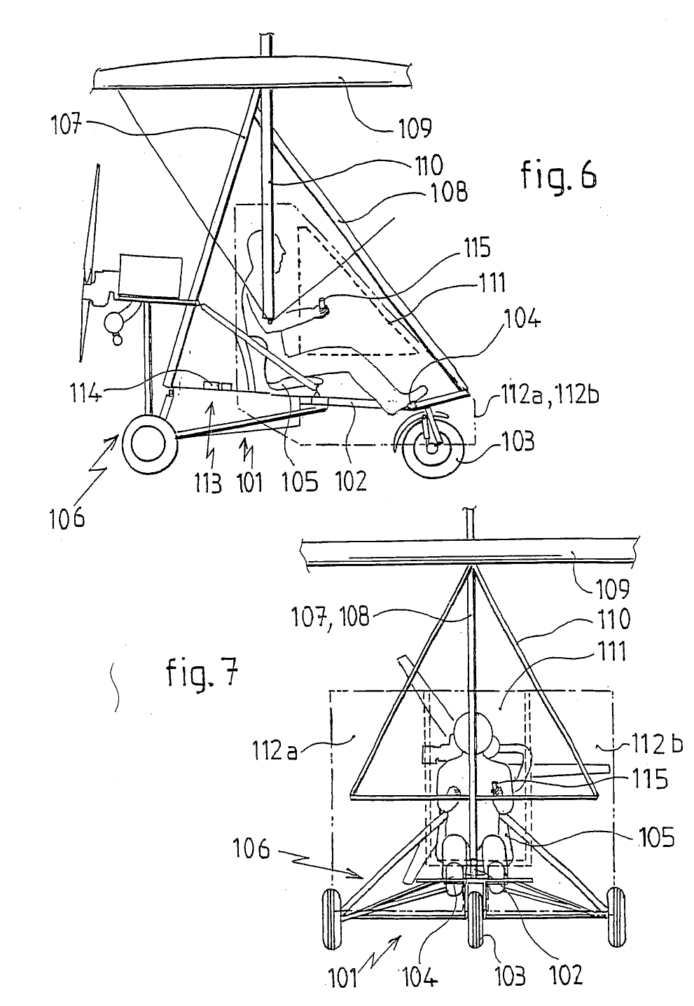

FIG. 6 is a side view of another embodiment of the safety device according to the invention placed on a ULM, in a deployed state;

FIG. 7 is a front view of the safety device according to the invention represented in FIG. 6;

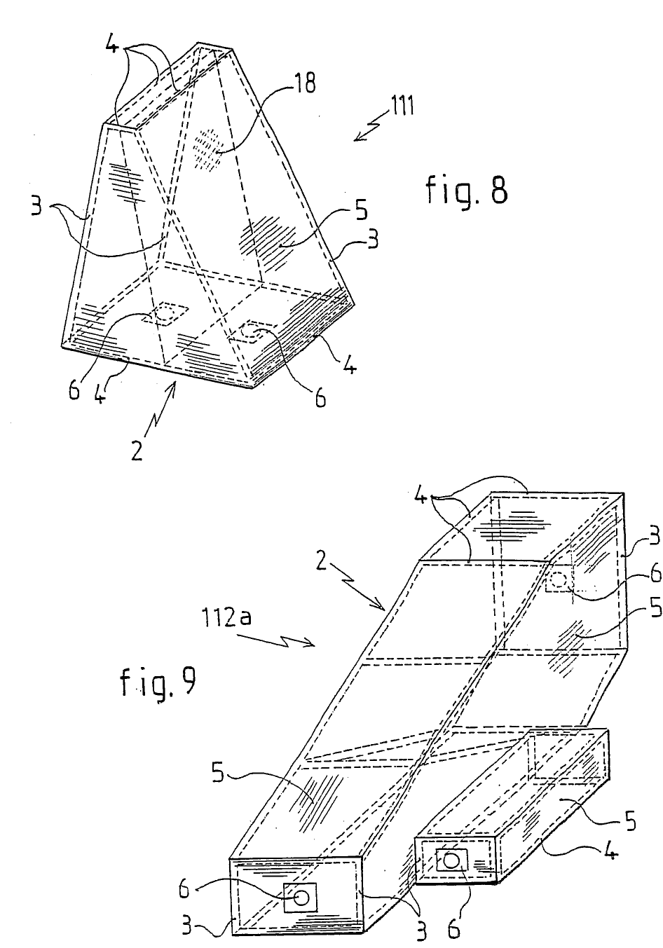

FIG. 8 is a perspective view of a side airbag of the safety device according to the invention;

FIG. 9 is a perspective view of the front airbag of the safety device according to the invention.

In this non restrictive example, we describe a safety device comprising an airbag made in cloth or like connected to inflating means automatically or manually activated so as to inflate said airbag at the time of impact especially used to protect a motorcyclist or a ULM pilot; all the same, the safety device according to the invention has numerous applications notably in the field of protection for people who practice hazardous activities or sports such as roofers, climbers, etc.

In reference to FIG. 1, the safety device according to the invention comprises an airbag 1 constituted of a frame 2 comprising longitudinal tubular elements 3, extending vertically in FIG. 1, and transversal tubular elements 4 in the shape of arcs whose ends are connected to the longitudinal tubular elements 3, said longitudinal 3 and transversal 4 tubular elements being made in an impervious and flexible material such as coated cloth, rubber, polyurethane, or similar. When the longitudinal 3 and transversal 4 tubular elements are inflated, at the time of impact with an obstacle as we will see later on, as represented in FIG. 1, said longitudinal 3 and transversal 4 tubular elements form a cylindrical frame. The device further comprises an outer wall 5 made in a flexible material such as cloth, preferably slightly pervious so as to avoid the exploding of the airbag at the time of an impact, integral with the frame 2 so as to form a closed cylindrical chamber filled with air at atmospheric pressure when the frame 2 is inflated as will be described later on.

It stands to reason that the frame 2 can comprise radial tubular elements and can consist of a single helical tubular element for example, whilst remaining within the scope of the invention.

To allow the filling of the closed chamber delimited by the outer wall of the airbag 1, in reference to FIGS. 1, 4 and 5, said outer wall 5 comprises, on the inside face of the cylinder, two valves 6 capable of opening when the frame 2 is being inflated and of closing when the airbag 1 hits an obstacle. In reference to FIGS. 4 and 5, each valve 6 consists of an orifice 7 of whatsoever shape, such as a square for example, made in the outer wall 5 and of a check valve 8 integral with the inside face of the outer wall 5 very slightly bigger than the size of the orifice 7, said check valve being capable of opening when the tubular elements inflate and closing at the time of impact. The check valve 8 consists, for example, of a square piece of impervious cloth of which one of the sides is stitched along one of the sides of the orifice 7 on the inside face of the outer wall 5.

It stands to reason that the check valve 8 can be integral with the inside face of the outer wall 5 by any appropriate means such as bonding or welding, whilst remaining within the scope of the invention.

Ultimately, the device advantageously comprises a grill 9 partially obstructing the orifice 7 of the valve 6 so as to prevent the check valve 8 from falling through said orifice 7 at the time of impact with an obstacle. Moreover, in reference to FIG. 1, the device comprises a main stack 10 made in cloth or like extending from the inside face to the upper face of the cylinder, preferably in a coaxial manner to the latter, said main stack 10 being open at its two ends which are integral with the outer wall 5. Additionally, the device comprises two secondary stacks 11 made in cloth or like extending in a radial manner from the main stack 10 to the outer wall 5, said secondary stacks 11 being open at their respective ends which are respectively integral with the main stack 10 and the outer wall 5. The main stack 10 and the secondary stacks 11 are used to integrate the head, the bust and the legs of the motorcyclist and respectively the arms of said pilot, the pilot's body being slipped inside said stacks constituted of a jacket when the airbag 1 is not inflated, as will be described later on.

Ultimately, the device comprises, in reference to FIG. 1, a semicircular airbag 12 integral with the inner face of the central stack 10 level with the pilot's nape, said semicircular airbag 12 being suitable for inflating when the motorbike hits an obstacle so as to protect the pilot's nape.

In order to inflate the frame 2, the device comprises inflating means 13 constituted of pyrotechnic means 14 connected to a longitudinal tubular element 3 and a transversal tubular element 4 by a flexible tube 15, and possibly a semicircular airbag 12, and in which the pyrotechnic means whose activation is ensured by a cable 16 fitted with a ring at its loose end intended to be attached to an appropriate place of the motorbike so that when the motorbike hits an obstacle and the pilot is ejected from said motorbike, the cable 16 is torn off releasing the striker of the pyrotechnic means 14 so as to inflate the frame 2.

Of course, the pyrotechnic means 14 can be replaced by any other equivalent means such as a carbon dioxide gas (CO₂) or diazonium (N₂) generator whilst remaining within the scope of the invention.

Moreover, it stands to reason that the cable 16 fitted with a ring 17 can be replaced by any other appropriate means of triggering such as an electronic or remote control means of triggering.

In a particularly advantageous manner, in reference to FIG. 2, the device comprises, on the inside of the volume delimited by the outer wall 5 integral with the frame 2, intermediary inner walls 18 extending in a radial manner from the central stack 10 to the outer wall 5 and vertically from the lower end to the upper end of the cylinder delimited by said outer wall 5. These intermediary inner walls 18 are integral with the inside face of the outer wall 5 or with the longitudinal tubular elements 3 of the frame 2, said intermediary inner walls 18 being made integral by any appropriate means such as bonding, welding or a line of stitching. The outer wall 5 comprising, on the inside face of the cylinder, valves 6 respectively projecting into a compartment delimited by two successive intermediary inner walls 18 so as to simultaneously inflate the compartments of the airbag 1 at the time of impact.

In a preferred embodiment of the safety device according to the invention in reference to FIG. 3, the central stack 10 and the secondary stacks 11 consist in a jacket 19 more or less in the form of a T-shirt or a chasuble, capable of being slipped on by a motorcyclist, generally by slipping the chasuble over the head with the arms raised, onto which is interlocked by any appropriate means, that being via stitching, welding or bonding, the longitudinal 3 and transversal 4 tubular elements as well as the outer wall 5, not represented in FIG. 3, which are folded and held in this folded state by two bits 20a and 20b, represented by dotted lines, made in flexible and light weight cloth such as cloth containing Lycra (registered trademark), placed on either side of the chasuble 19, that being on the back and torso of the pilot, said bits of cloth 20a and 20b being interlocked at the pilot's shoulders and side of torso via buckle and fastener means of attachment 21 such as Velcro (registered trademark). Thus, when the motorcyclist who has already slipped the chasuble 19 on hits an obstacle, the latter is ejected from his machine provoking the tearing off of the cable 16 which releases the striker of the pyrotechnic means 14 connected to the longitudinal 3 and transversal 4 tubular elements which, when under pressure inflate, deploying the frame 2 by filling the volume delimited by the outer wall 5 with air. The deploying of the frame 2 produces the tearing off of the bits of cloth 20a and 20b which maintained the tubular elements 3 and 4 of the frame 2 as well as the outer wall 5 in the folded state.

According to an embodiment of the safety device in compliance with the invention, in the field of ULM aircraft, that being ultra light motorised aircraft, in reference to FIGS. 6 to 9, usually constituted of a tubular chassis 101 comprising a longitudinal central tube 102 equipped with a steering wheel 103 at the front in free rotation and equipped with pedals 104 onto which the aircraft pilot rests his feet, a seat 105 in its central location onto which the pilot sits, a rear driving axle integral with the rear section 106 of said longitudinal central tube 102 and struts 107 and 108 respectively integral with the front and rear ends of said central tube 102 onto which a hang glider 109 is swivel mounted capable of being piloted by a control frame 110. The device comprises a front airbag 111 and two side airbags 112a and 112b used to protect the pilot at the time of impact. The front airbag 111, represented by dotted lines, and the two side airbags 112a and 112b, represented by dot and dash lines, are initially contained in a casing integral with the front section of the ULM, preferably on the longitudinal central tube 102 of the ULM. The device further comprises means of inflating 113 consisting of a bottle 114 of compressed carbon dioxide gas or like located at the rear of the pilot's seat 105 capable of being activated via manual or electric means of activation 115 such as a switch within hand's-reach of the pilot so that the latter can activate the safety device prior to impact.

In reference to FIGS. 8 and 9, the front airbag 111 and the side airbags 112a and 112b are constituted of, on one hand, a frame 2 comprising longitudinal 3 and transversal 4 tubular elements connected together so as to form a generally parallelepiped frame 2 when said tubular elements are inflated and, on the other hand, an outer wall 5 made in flexible cloth integral with the frame 2 so as to form a closed chamber filled with air at atmospheric pressure, said outer wall 5 comprising at least a valve 6 such as is described above which opens when the frame 2 is inflated and which closes at the time of impact. In the same manner as above, the device can comprise, on the inside of the volume delimited by the outer wall integral with the frame 2, at least an intermediary inner wall 18, represented by dotted lines in FIG. 8, integral with the inside face of the outer wall 5 and/or the frame 2, said outer wall 5 being equipped with at least a valve 6 projecting into the volume delimited by the intermediary inner wall 18 and which opens when the frame is inflated and which closes at the time of impact. In this non restrictive embodiment, in reference to FIGS. 8 and 9, the front airbag 111 is, when inflated, generally trapezoidal and the side airbags 112a and 112b are generally parallelepiped.

It stands to reason that the front airbag 111 and the side airbags 112a and 112b can be of whatsoever shape such as spherical, cylindrical, hemispherical, etc. whilst remaining within the scope of the invention.

We noticed that the gas contained inside the airbag is essentially constituted of air at atmospheric pressure so that the device according to the invention can advantageously be used by hikers or skiers off-piste in the event of being buried by an avalanche where the air of the airbag will advantageously ensure the survival of the hikers.

Finally, it is obvious that the safety device according to the invention can be used by firemen as a means of catching a falling body, by sports people such as those who practise climbing, canyonning or paragliding or by those who conduct hazardous activities and can be used with any means of transport, such as motorbikes, aeroplanes, cars, etc. and that the examples we have just given are only specific illustrations in no way restrictive as to the fields of application of the invention.

1. Safety device disassociated or integral with a means of transport, with its pilot's body or with the body of any other person practising a hazardous sport or activity to protect said body, comprising an airbag (1, 111, 112a, 112b) or similar connected to inflating means (13) automatically or manually activated so as to inflate said airbag upon impact, characterised in that the airbag (1) is, on one hand, constituted of a frame (2) comprising at least a tubular element so as to form a cylindrical, spherical, parallelepiped or like frame (2), when the tubular element (3, 4) is inflated, said tubular element (3, 4) being initially folded in a container integral, for example, with the means of transport and/or the human body and connected to the inflating means (13) and, on the other hand, of an outer wall (5) made of a flexible material integral with the frame (2) so as to form a closed chamber filled with air at atmospheric pressure, said outer wall (5) comprising at least a valve (6) which opens when the frame (2) is being inflated and which closes at the time of impact.

2. Safety device set forth in claim 1, characterised in that it comprises, on the inside of the volume delimited by the outer wall (5) integral with the frame (2), at least an intermediary inner wall (18) integral with the inside face of the outer wall (5) and/or the frame (2), said outer wall (5) being equipped with at least a valve (6) projecting into the volume delimited by the intermediary inner wall (18) and which opens when the frame (2) is inflated and which closes at the time of impact.

3. Safety device set forth in claim 1, characterised in that it comprises at least a main stack (10) made in cloth or like which extends from two faces opposite the outer wall (5), said stack (10) being open at its two ends which are integral with said outer wall (5).

4. Safety device set forth in claim 3, characterised in that it comprises at least a secondary stack (11) made in cloth or like which extends from the main stack (10) to the outer wall (5), said secondary stack (11) being open at its two ends which are respectively integral with the main stack (10) and the outer wall (5).

5. Safety device set forth in claim 1, characterised in that the valve (6) consists, on one hand, of an orifice (7) made in the outer wall (5) and, on the other hand, of a check valve (8) integral with the inside face of the outer wall (5) and which is very slightly bigger than the orifice (7), said check valve (8) being capable of opening when the tubular elements (3, 4) inflate and closing at the time of impact.

6. Safety device set forth in claim 5, characterised in that it comprises a grill (9) partially obstructing the orifice (7) of the valve (6).

7. Safety device set forth in claim 1, characterised in that the inflating means (13) consists of a bottle of compressed gas (114).

8. Safety device set forth in claim 1, characterised in that the inflating means (13) consist of pyrotechnic means (14).

9. Implementing of the safety device set forth in claim 1, to a ULM type flying apparatus comprising a front airbag (111) and two side airbags (112a and 112b).

10. Safety device set forth in claim 2, characterised in that it comprises at least a main stack (10) made in cloth or like which extends from two faces opposite the outer wall (5), said stack (10) being open at its two ends which are integral with said outer wall (5).

11. Safety device set forth in claim 10, characterised in that it comprises at least a secondary stack (11) made in cloth or like which extends from the main stack (10) to the outer wall (5), said secondary stack (11) being open at its two ends which are respectively integral with the main stack (10) and the outer wall (5).
